(19) United States
(12) Patent Application Publication
(10) Pub. No.: US 2025/0031178 A1
(43) Pub. Date: Jan. 23, 2025

(54) APPARATUSES AND METHODS FOR ENHANCED POSITIONING SUPPORTED BY POSITIONING REFERENCE UNITS

(71) Applicant: Nokia Technologies Oy, Espoo (FI)

(72) Inventors: Shubhranshu SINGH, Munich (DE); Laurent THIEBAUT, Massy (FR); Mao CAI, Chengdu (CN); Sankaran BALASUBRAMANIAM, Bangalore (IN)

(21) Appl. No.: 18/446,821

(22) Filed: Aug. 9, 2023

(30) Foreign Application Priority Data
Jul. 19, 2023 (CN) 202310884934.5

(51) Int. Cl. H04W 64/00; H04W 60/04

(52) U.S. Cl. CPC H04W 64/006; H04W 60/04

(57) ABSTRACT

A PRU requests registration with a cellular network, participates in a procedure to locate the PRU within the network, and associates itself as a PRU with network element(s). A repository receives information for a PRU describing at least a position of the PRU, and stores this. In response to a request by a requesting network element for positioning information of the PRU, the repository sends at least part of the information for the PRU to the network element. A network element implementing an LMF receives, from a first network element, a request for positioning of a target UE, and selects a PRU serving the target UE. The network element receives a first location of the target UE and determines a final location of the target UE considering position information of the PRU and the first location of the target UE, and provides the final location to the first network element.

### CROSS-REFERENCE TO RELATED APPLICATIONS

This application claims the benefit of priority of Chinese Patent Application No. Chinese Patent Application No. 202310884934.5 filed Jul. 19, 2023, which is hereby incorporated by reference as if reproduced in its entirety.

### TECHNICAL FIELD

Examples of embodiments herein relate generally to wireless communication systems and, more specifically, relate to apparatuses and methods for performing positioning determination of devices in the wireless communication systems.

### BACKGROUND

In a wireless communication network, such as a cellular network, positioning reference units (PRUs) can be used for positioning (i.e., determining locations) of wireless communication devices within the geographical region covered by the cellular networks. A PRU at a known location can perform positioning measurements and report these measurements to a location server. Such positioning measurements may include reference signal time difference, RSTD; reference signal received power, RSRP; user equipment, UE, receiver-transmitter, Rx-Tx, time difference measurements, and the like. In addition, the PRU can transmit sounding reference signals (SRSs) to enable transmission-reception points (TRPs) to measure and report uplink (UL) positioning measurements (e.g., relative time of arrival, RTOA; uplink angle of arrival, UL-AoA; gNB Rx-Tx time difference, and the like) from the PRU at its known location. The PRU measurements can be compared by, e.g., a location server with the measurements expected at the known PRU location to determine correction terms for other nearby target devices. The DL- and/or UL-location measurements for other target devices can then be corrected based on the previously determined correction terms. From a location server perspective, the PRU functionality may be realized by, e.g., a UE with a known location. See more information in 3GPP TS 38.305.

For cellular networks, the wireless communication devices are typically referred to as UEs, and these may be many types of wireless communication devices located in the geographical region covered by a cellular network. For example, a warehouse may include a cellular network and the PRU could be used for positioning (i.e., determine a location of) a forklift within the warehouse. Alternatively, a state may be covered by a cellular network that includes PRUs, and the PRUs may be used for positioning delivery trucks in the state. PRUs could also be used for positioning vehicles for emergency services (e.g., something happened to a vehicle), accident avoidance (e.g., upcoming traffic has stopped), or many other use cases.

PRUs may be fixed or mobile, and PRUs may also provide their location (i.e., geographic coordinates) to the cellular network if the PRUs obtain their location using the global positioning system (GPS) or other means.

There are limitations with how a cellular network uses PRUs for positioning wireless communication devices within the cellular network.

### BRIEF SUMMARY

This section is intended to include examples and is not intended to be limiting.

In an exemplary embodiment, a method is disclosed that includes requesting, by a positioning reference unit within a cellular network, registration of the positioning reference unit with the cellular network; and participate, by the positioning reference unit with one or more network elements in the cellular network, in a procedure to locate the positioning reference unit within the cellular network and to associate this positioning reference unit as a positioning reference unit with at least one network element in the cellular network.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: requesting, by a positioning reference unit within a cellular network, registration of the positioning reference unit with the cellular network; and participate, by the positioning reference unit with one or more network elements in the cellular network, in a procedure to locate the positioning reference unit within the cellular network and to associate this positioning reference unit as a positioning reference unit with at least one network element in the cellular network.

An exemplary computer program product includes a computer-readable storage medium bearing instructions that, when executed by an apparatus, cause the apparatus to perform at least the following: requesting, by a positioning reference unit within a cellular network, registration of the positioning reference unit with the cellular network; and participate, by the positioning reference unit with one or more network elements in the cellular network, in a procedure to locate the positioning reference unit within the cellular network and to associate this positioning reference unit as a positioning reference unit with at least one network element in the cellular network.

In another exemplary embodiment, an apparatus comprises means for performing: requesting, by a positioning reference unit within a cellular network, registration of the positioning reference unit with the cellular network; and participate, by the positioning reference unit with one or more network elements in the cellular network, in a procedure to locate the positioning reference unit within the cellular network and to associate this positioning reference unit as a positioning reference unit with at least one network element in the cellular network.

In an exemplary embodiment, a method is disclosed that includes at a first network element in a cellular network, obtaining information for a positioning reference unit in the cellular network; and providing, by the first network element to a repository, at least the information for the positioning reference unit, for storage by the repository for use in positioning a user equipment in the cellular network.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: at a first network element in a cellular network, obtaining information for a positioning reference unit in the cellular network; and providing, by the first network element to a repository, at least the information for the positioning reference unit, for storage by the repository for use in positioning a user equipment in the cellular network.

An exemplary computer program product includes a computer-readable storage medium bearing instructions that, when executed by an apparatus, cause the apparatus to perform at least the following: at a first network element in a cellular network, obtaining information for a positioning reference unit in the cellular network; and providing, by the first network element to a repository, at least the information for the positioning reference unit, for storage by the repository for use in positioning a user equipment in the cellular network.

In another exemplary embodiment, an apparatus comprises means for performing: at a first network element in a cellular network, obtaining information for a positioning reference unit in the cellular network; and providing, by the first network element to a repository, at least the information for the positioning reference unit, for storage by the repository for use in positioning a user equipment in the cellular network.

In an exemplary embodiment, a method is disclosed that includes receiving, by a repository for a cellular network, information for a positioning reference unit describing at least a position of the positioning reference unit in the cellular network; storing by the repository the information for the positioning reference unit; and in response to a request by a requesting network element for positioning information of the positioning reference unit, sending, by the repository, at least part of the information for the positioning reference unit to the requesting network element.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, by a repository for a cellular network, information for a positioning reference unit describing at least a position of the positioning reference unit in the cellular network; storing by the repository the information for the positioning reference unit; and in response to a request by a requesting network element for positioning information of the positioning reference unit, sending, by the repository, at least part of the information for the positioning reference unit to the requesting network element.

An exemplary computer program product includes a computer-readable storage medium bearing instructions that, when executed by an apparatus, cause the apparatus to perform at least the following: receiving, by a repository for a cellular network, information for a positioning reference unit describing at least a position of the positioning reference unit in the cellular network; storing by the repository the information for the positioning reference unit; and in response to a request by a requesting network element for positioning information of the positioning reference unit, sending, by the repository, at least part of the information for the positioning reference unit to the requesting network element.

In another exemplary embodiment, an apparatus comprises means for performing: receiving, by a repository for a cellular network, information for a positioning reference unit describing at least a position of the positioning reference unit in the cellular network; storing by the repository the information for the positioning reference unit; and in response to a request by a requesting network element for positioning information of the positioning reference unit, sending, by the repository, at least part of the information for the positioning reference unit to the requesting network element.

In an exemplary embodiment, a method is disclosed that includes receiving, at a first network element in a cellular network, a request for positioning of a target user equipment from a repository in the cellular network; selecting a second network element in the cellular network that serves the target user equipment; sending, from the first network element to the second network element, a location request for a location of the target user equipment; receiving, by the first network element from the second network element, a response to the location request comprising an identifier of a positioning reference unit associated with the target user equipment and to be used for determining a position of the target user equipment; determining, by the first network element, position information of the positioning reference unit; and updating, by the first network element, the repository with the position information of the positioning reference unit serving the target user equipment, the position information corresponding to the positioning reference unit to be used for the positioning of the target user equipment.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, at a first network element in a cellular network, a request for positioning of a target user equipment from a repository in the cellular network; selecting a second network element in the cellular network that serves the target user equipment; sending, from the first network element to the second network element, a location request for a location of the target user equipment; receiving, by the first network element from the second network element, a response to the location request comprising an identifier of a positioning reference unit associated with the target user equipment and to be used for determining a position of the target user equipment; determining, by the first network element, position information of the positioning reference unit; and updating, by the first network element, the repository with the position information of the positioning reference unit serving the target user equipment, the position information corresponding to the positioning reference unit to be used for the positioning of the target user equipment.

An exemplary computer program product includes a computer-readable storage medium bearing instructions that, when executed by an apparatus, cause the apparatus to perform at least the following: receiving, at a first network element in a cellular network, a request for positioning of a target user equipment from a repository in the cellular network; selecting a second network element in the cellular network that serves the target user equipment; sending, from the first network element to the second network element, a location request for a location of the target user equipment; receiving, by the first network element from the second network element, a response to the location request comprising an identifier of a positioning reference unit associated with the target user equipment and to be used for determining a position of the target user equipment; determining, by the first network element, position information of the positioning reference unit; and updating, by the first network element, the repository with the position information of the positioning reference unit serving the target user equipment, the position information corresponding to the positioning reference unit to be used for the positioning of the target user equipment.

In another exemplary embodiment, an apparatus comprises means for performing: receiving, at a first network element in a cellular network, a request for positioning of a target user equipment from a repository in the cellular network; selecting a second network element in the cellular network that serves the target user equipment; sending, from the first network element to the second network element, a location request for a location of the target user equipment; receiving, by the first network element from the second network element, a response to the location request comprising an identifier of a positioning reference unit associated with the target user equipment and to be used for determining a position of the target user equipment; determining, by the first network element, position information of the positioning reference unit; and updating, by the first network element, the repository with the position information of the positioning reference unit serving the target user equipment, the position information corresponding to the positioning reference unit to be used for the positioning of the target user equipment.

In an exemplary embodiment, a method is disclosed that includes receiving, at a network element implementing a location management function in a cellular network and from a first network element, a request for positioning of a target user equipment; selecting a positioning reference unit serving the target user equipment, wherein the positioning reference unit is able to provide positioning information associated with itself to the cellular network; receiving, by the network element, a first location of the target user equipment; determining, by the network element, a final location of the target user equipment considering position information of the positioning reference unit and the first location of the target user equipment; and providing by the network element the final location of the target user equipment to the first network element.

An additional exemplary embodiment includes a computer program, comprising instructions for performing the method of the previous paragraph, when the computer program is run on an apparatus. The computer program according to this paragraph, wherein the computer program is a computer program product comprising a computer-readable medium bearing the instructions embodied therein for use with the apparatus. Another example is the computer program according to this paragraph, wherein the program is directly loadable into an internal memory of the apparatus.

An exemplary apparatus includes one or more processors and one or more memories storing instructions that, when executed by the one or more processors, cause the apparatus at least to perform: receiving, at a network element implementing a location management function in a cellular network and from a first network element, a request for positioning of a target user equipment; selecting a positioning reference unit serving the target user equipment, wherein the positioning reference unit is able to provide positioning information associated with itself to the cellular network; receiving, by the network element, a first location of the target user equipment; determining, by the network element, a final location of the target user equipment considering position information of the positioning reference unit and the first location of the target user equipment; and providing by the network element the final location of the target user equipment to the first network element.

An exemplary computer program product includes a computer-readable storage medium bearing instructions that, when executed by an apparatus, cause the apparatus to perform at least the following: receiving, at a network element implementing a location management function in a cellular network and from a first network element, a request for positioning of a target user equipment; selecting a positioning reference unit serving the target user equipment, wherein the positioning reference unit is able to provide positioning information associated with itself to the cellular network; receiving, by the network element, a first location of the target user equipment; determining, by the network element, a final location of the target user equipment considering position information of the positioning reference unit and the first location of the target user equipment; and providing by the network element the final location of the target user equipment to the first network element.

In another exemplary embodiment, an apparatus comprises means for performing: receiving, at a network element implementing a location management function in a cellular network and from a first network element, a request for positioning of a target user equipment; selecting a positioning reference unit serving the target user equipment, wherein the positioning reference unit is able to provide positioning information associated with itself to the cellular network; receiving, by the network element, a first location of the target user equipment; determining, by the network element, a final location of the target user equipment considering position information of the positioning reference unit and the first location of the target user equipment; and providing by the network element the final location of the target user equipment to the first network element.

### BRIEF DESCRIPTION OF THE DRAWINGS

In the attached drawings:

FIG. 1 is a block diagram of one possible and non-limiting exemplary system in which the exemplary embodiments may be practiced;

FIG. 2 is an example of a cellular network providing location of UEs;

FIG. 3 is a signaling diagram of PRU information creation/updating;

FIGS. 3A, 3B, and 3C are flowcharts of methods performed by a PRU, an AMF, and a repository, respectively, in FIG. 3;

FIG. 4, split over FIGS. 4A and 4B, is a signaling diagram of target UE location determination considering a PRU; and

FIGS. 5A, 5B, and 5C are flowcharts of methods performed by a repository, an AMF, and an LMF (for a target UE), respectively, in FIG. 4.

### DETAILED DESCRIPTION OF THE DRAWINGS

Abbreviations that may be found in the specification and/or the drawing figures are defined below, at the end of the detailed description section.

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

When more than one drawing reference numeral, word, or acronym is used within this description with “/”, and in general as used within this description, the “/” may be interpreted as “or”, “and”, or “both”.

As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

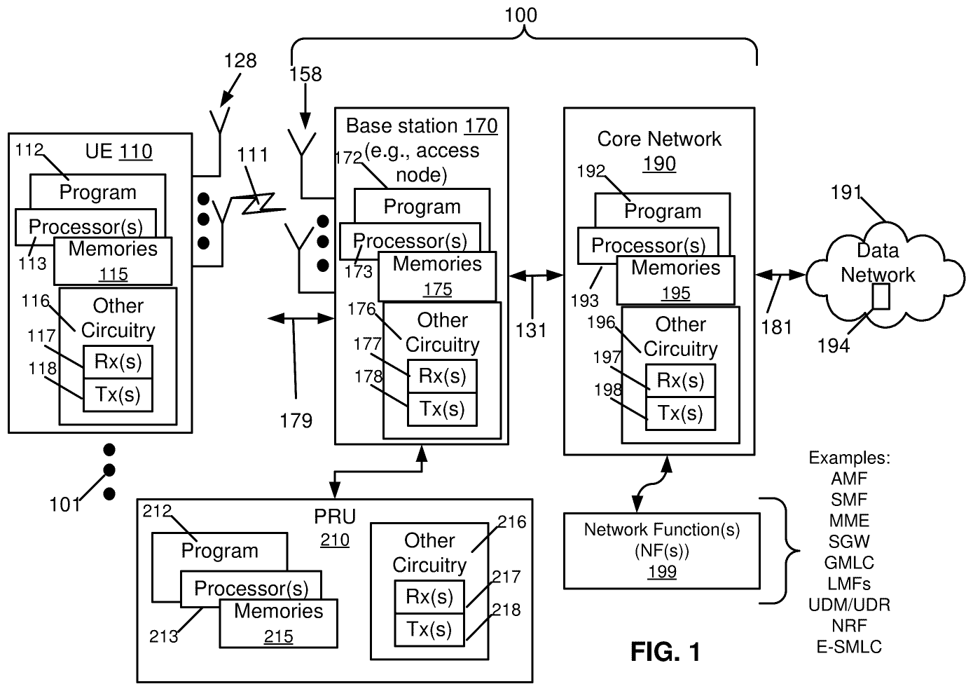

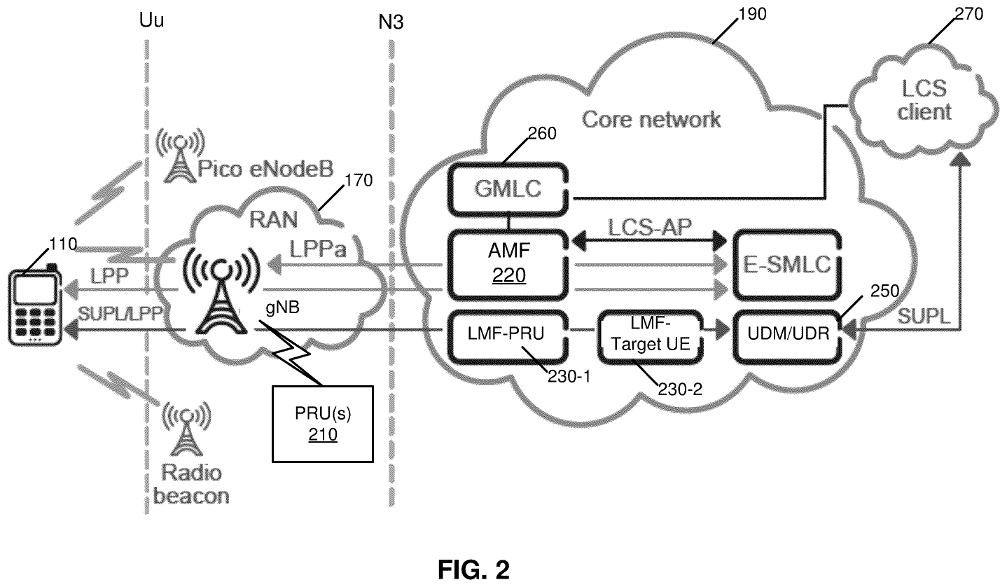

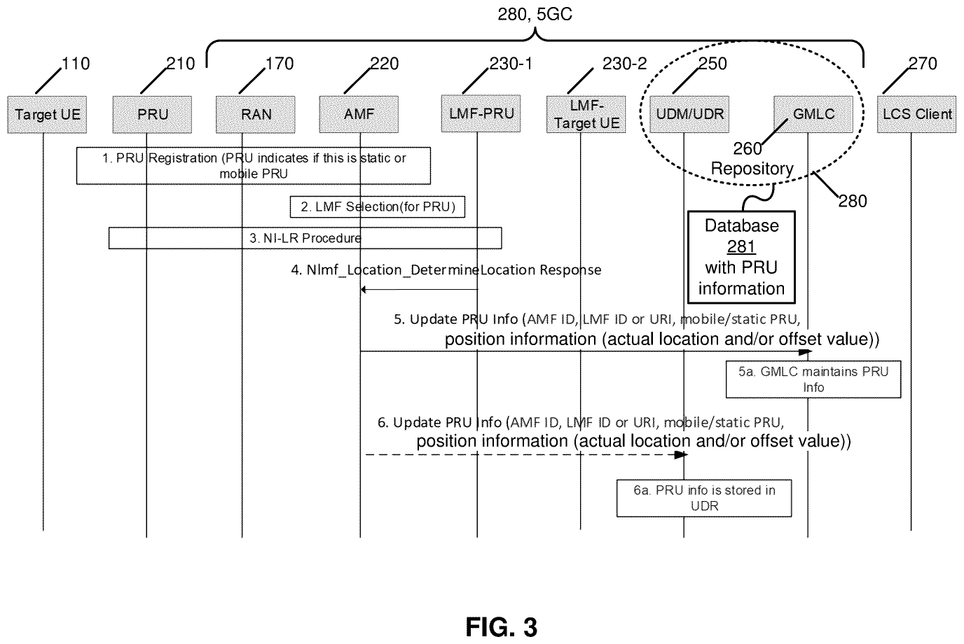

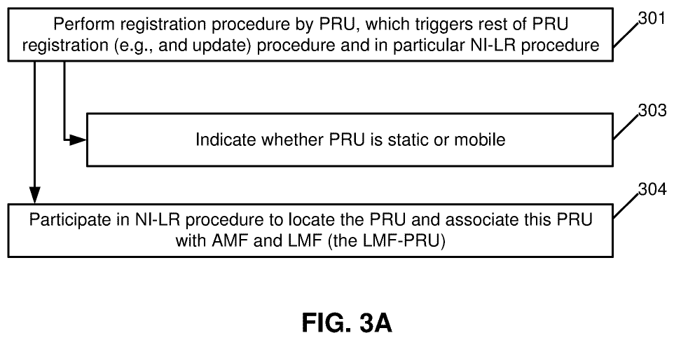

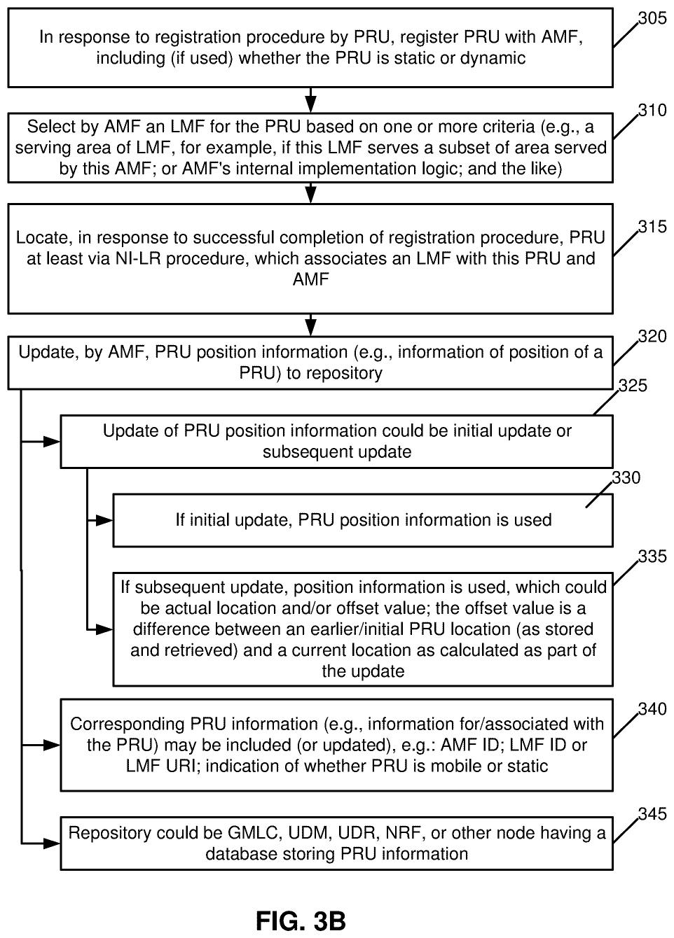

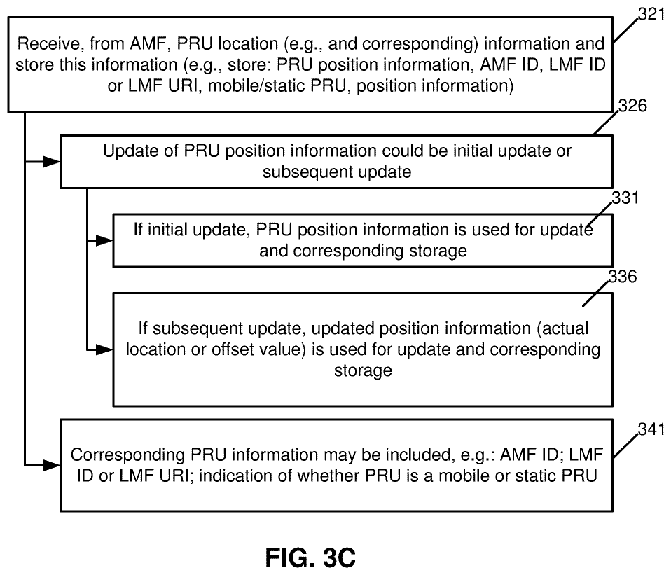

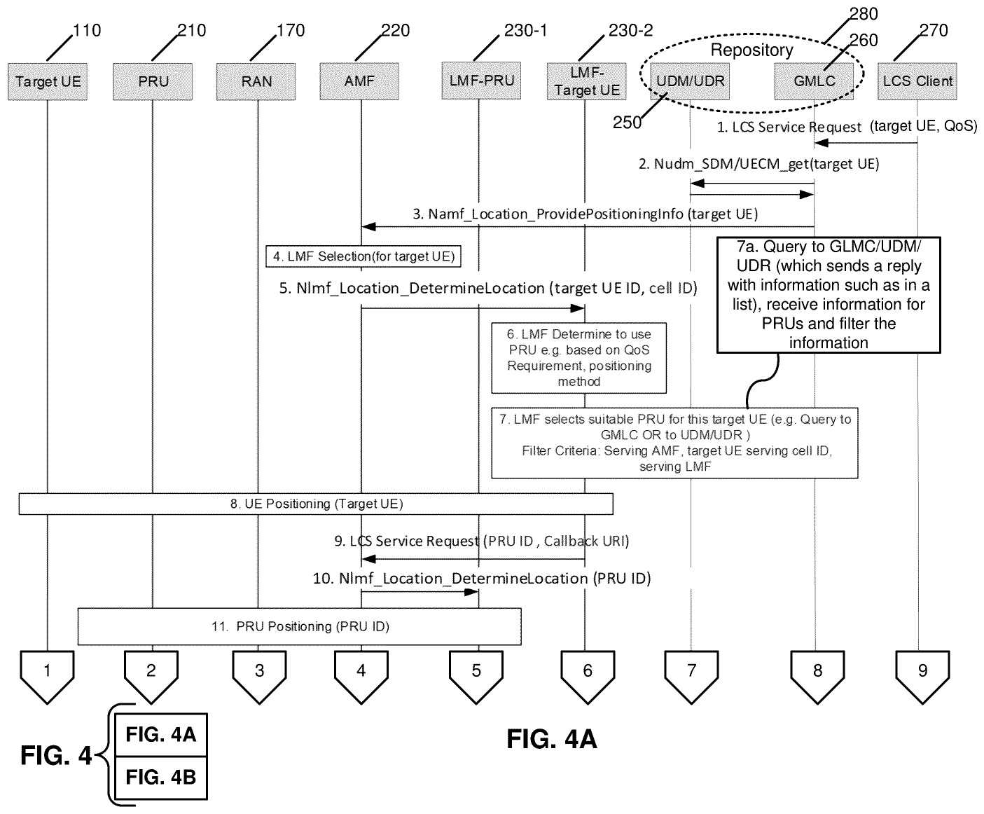

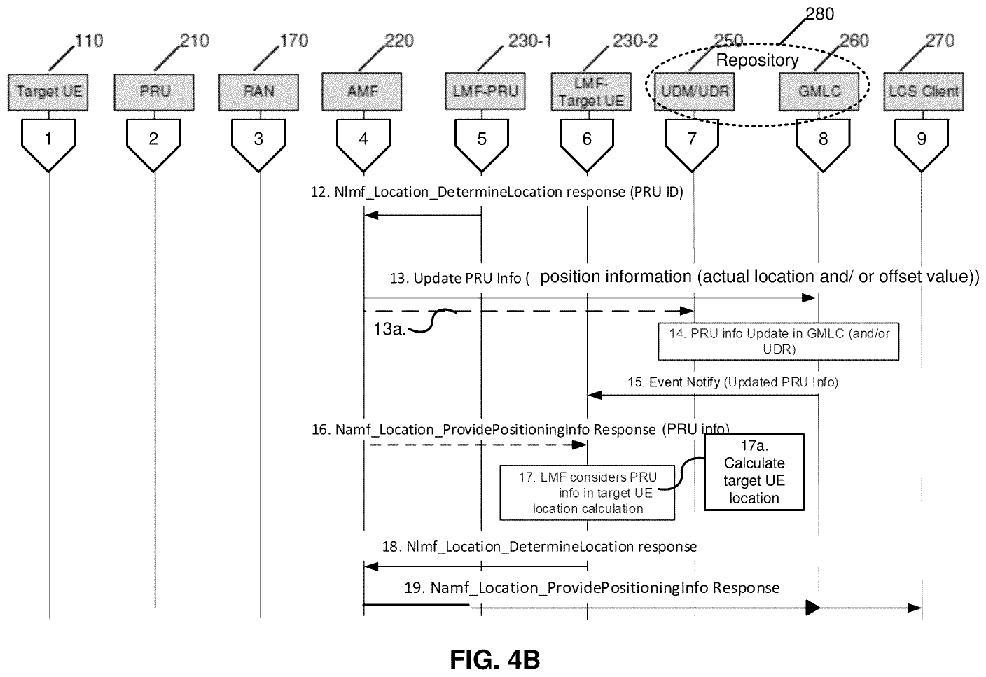

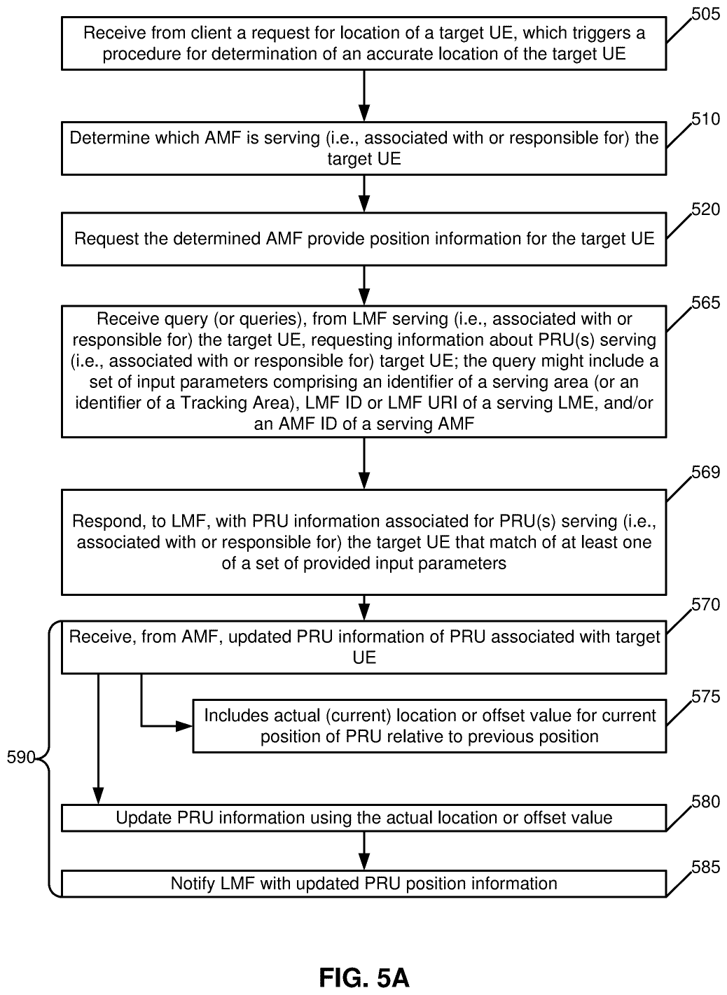

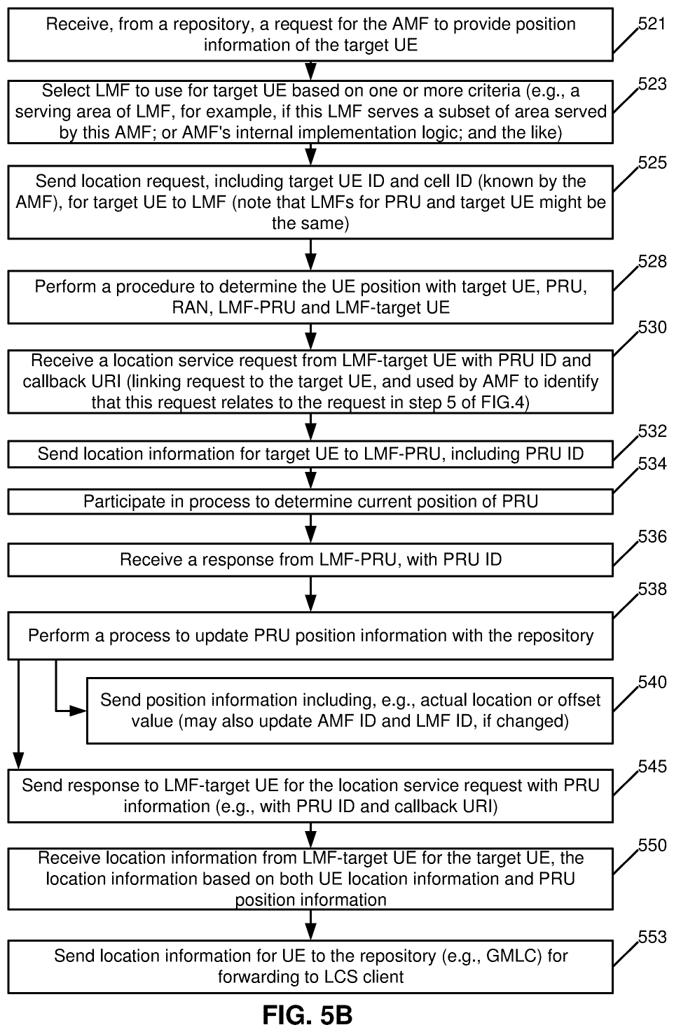

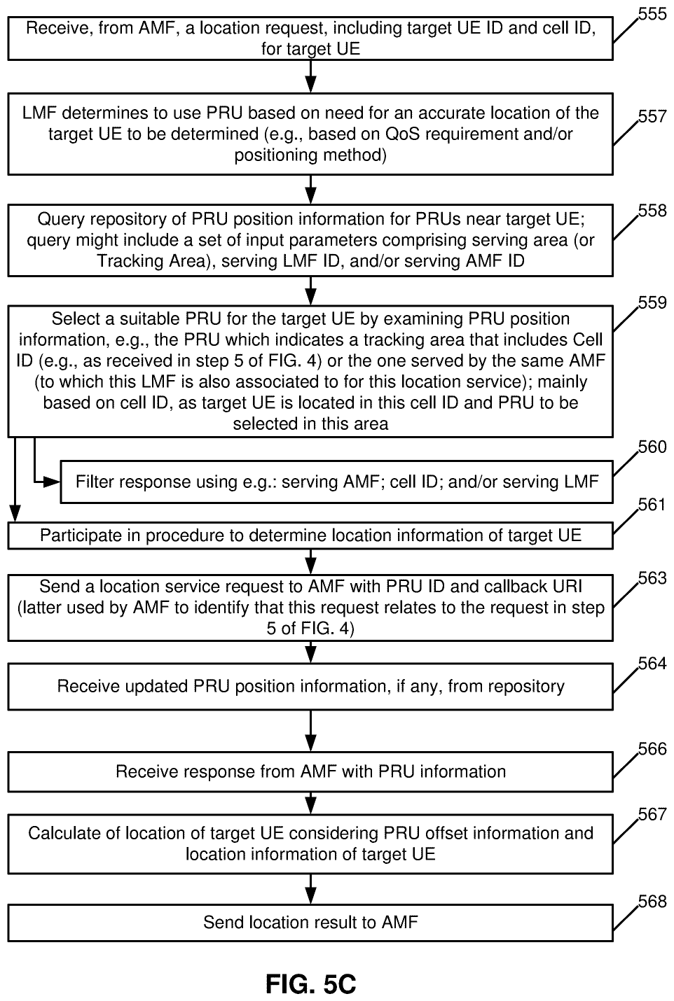

Any flow diagram (such as FIGS. 3A, 3B, 3C, 5A, 5B, and 5C) or signaling diagram (such as FIGS. 3 and 4) herein is considered to be a logic flow diagram, and illustrates the operation of an exemplary method, results of execution of computer program instructions embodied on a computer readable memory, functions performed by logic implemented in hardware, and/or interconnected means for performing functions in accordance with an exemplary embodiment. Block diagrams (such as FIGS. 1 and 2) also illustrate the operation of an exemplary method, results of execution of computer program instructions embodied on a computer readable memory, functions performed by logic implemented in hardware, and/or interconnected means for performing functions in accordance with an exemplary embodiment.

The exemplary embodiments herein describe methods and apparatuses for enhanced positioning of wireless communications devices in cellular networks, such as 5G networks that include positioning reference units. Additional description of these apparatuses and methods is presented after an exemplary embodiment of a cellular network is described.

Turning to FIG. 1, this figure shows a block diagram of one possible and non-limiting example of a cellular network 100 that is connected to a user equipment (UE) 110. A number of network elements are shown in the cellular network of FIG. 1: a base station 170; a core network 190, and a PRU 210.

In FIG. 1, a user equipment (UE) 110 is in wireless communication via radio link 111 with the base station 170 of the cellular network 100. A UE 110 is a wireless communication device, such as a mobile device, that is configured to access a cellular network. The UE 110 is illustrated with one or more antennas 128. The ellipses 101 indicate there could be multiple UEs 110 in wireless communication via radio links with the base station 170. The UE 110 includes one or more processors 113, one or more memories 115, and other circuitry 116. The other circuitry 116 includes one or more receivers (Rx(s)) 117 and one or more transmitters (Tx(s)) 118. A program 112 is used to cause the UE 110 to perform the operations described herein. For a UE 110, the other circuitry 116 could include circuitry such as for user interface elements (not shown) like a display.

The base station 170, as a network element of the cellular network 100, provides the UE 110 access to cellular network 100 and to the data network 191 via the core network 190 (e.g., via a user plane function (UPF) of the core network 190). The base station 170 is illustrated as having one or more antennas 158. In general, the base station 170 is referred to as RAN node 170 herein. An example of a RAN node 170 is a gNB. There are, however, many other examples of RAN nodes including an eNB or TRP. The base station 170 includes one or more processors 173, one or more memories 175, and other circuitry 176. The other circuitry 176 includes one or more receivers (Rx(s)) 177 and one or more transmitters (Tx(s)) 178. A program 172 is used to cause the base station 170 to perform the operations described herein.

It is noted that the base station 170 may instead be implemented via other wireless technologies, such as Wi-Fi (a wireless networking protocol that devices use to communicate without direct cable connections). In the case of Wi-Fi, the link 111 could be characterized as a wireless link.

Two or more base stations 170 communicate using, e.g., link(s) 179. The link(s) 179 may be wired or wireless or both and may implement, e.g., an Xn interface for 5G, an X2 interface for LTE, or other suitable interface for other standards.

The cellular network 100 may include a core network 190, as a third illustrated element or elements, that may include core network functionality, and which provide connectivity via a link or links 181 with a data network 191, such as a telephone network and/or a data communications network (e.g., the Internet). The core network 190 includes one or more processors 193, one or more memories 195, and other circuitry 196. The other circuitry 196 includes one or more receivers (Rx(s)) 197 and one or more transmitters (Tx(s)) 198. A program 192 is used to cause the core network 190 to perform the operations described herein.

The core network 190 could be a 5GC (5G core network). The core network 190 can implement or comprise multiple network functions (NF(s)) 199, and the program 192 may comprise one or more of the NFs 199. A 5G core network may use hardware such as memory and processors and a virtualization layer. It could be a single standalone computing system, a distributed computing system, or a cloud computing system. The NFs 199, as network elements, of the core network could be containers or virtual machines running on the hardware of the computing system(s) making up the core network 190.

Core network functionality for 5G may include access and mobility management functionality that is provided by a network function 199 such as an access and mobility management function (AMF(s)), session management functionality that is provided by a network function such as a session management function (SMF). Core network functionality for access and mobility management in an LTE network may be provided by an MME (Mobility Management Entity) and/or SGW (Serving Gateway) functionality, which routes data to the data network. Many others are possible, as illustrated by the examples in FIG. 1: AMF; SMF; MME; SGW; GMLC; LMFs; UDM/UDR; NRF; and/or E-SMLC. These are merely exemplary core network functionality that may be provided by the core network 190, and note that both 5G and LTE core network functionality might be provided by the core network 190. The RAN node 170 is coupled via a backhaul link 131 to the core network 190. The RAN node 170 and the core network 190 may include an NG interface for 5G, or an S1 interface for LTE, or other suitable interface for other radio access technologies for communicating via the backhaul link 131.

A single PRU 210 is shown, but that is only an example, as multiple PRUs 210 can be used. The PRU 210 includes one or more processors 213, one or more memories 215, and other circuitry 216. The other circuitry 216 includes one or more receivers (Rx(s)) 217 and one or more transmitters (Tx(s)) 218. A program 212 is used to cause the PRU 210 to perform the operations described herein.

In the data network 191, there is a computer-readable medium 194. The computer-readable medium 194 contains instructions that, when downloaded and installed into the memories 115, 175, 195, or 215 of the corresponding UE 110, base station 170, core network element(s) 190, and/or PRU 210, and executed by processor(s) 113, 173, 193, or 213, cause the respective device to perform corresponding actions described herein. The computer-readable medium 194 may be implemented in other forms, such as via a compact disc or memory stick.

The programs 112, 172, 192, and 212 contain instructions stored by corresponding one or more memories 115, 175, 195, or 215. These instructions, when executed by the corresponding one or more processors 113, 173, 193, and 213, cause the corresponding apparatus 110, 170, 190, and 210 to perform the operations described herein. The computer readable memories 115, 175, 195, and 215 may be of any type suitable to the local technical environment and may be implemented using any suitable data storage technology, such as semiconductor-based memory devices, flash memory, firmware, magnetic memory devices and systems, optical memory devices and systems, fixed memory and removable memory. The computer readable memories 115, 175, 195, and 215 may be means for performing storage functions. The processors 113, 173, 193, and 213 may be of any type suitable to the local technical environment, and may include one or more of general-purpose computers, special purpose computers, microprocessors, digital signal processors (DSPs) and processors based on a multi-core processor architecture, as non-limiting examples. The processors 113, 173, 193, and 213 may be means for causing their respective apparatus to perform functions, such as those described herein.

The receivers 117, 177, 197, and 217, and the transmitters 118, 178, 198, and 218 may implement wired or wireless interfaces. The receivers and transmitters may be grouped together as transceivers.

It is noted that description herein indicates that “cells” perform functions, but it should be clear that the base station that forms the cell will perform the functions. The cell is provided by a base station. That is, there can be multiple cells per base station. For instance, there could be three cells for a single carrier frequency and associated bandwidth, each cell covering one-third of a 360-degree area so that a single base station's coverage area covers an approximate oval or circle. Furthermore, each cell can correspond to a single carrier and a base station may use multiple carriers. So, if there are three 120-degree cells per carrier and two carriers, then the base station has a total of six cells.

FIG. 2 is an example of a cellular network providing location of UEs. FIG. 2 shows a UE 110 that is in communication over a Uu interface with a RAN 170 (illustrated as a gNB) and also with a pico eNodeB and a radio beacon. One or more PRUs 210 are able to communicate with the RAN 170. The core network 190 includes a GMLC 260, an AMF 220, an LMF 230-1 serving (i.e., associated with or responsible for) a PRU 210, an LMF 230-2 serving (i.e., associated with or responsible for) a target UE (e.g., UE 110), a UDM/UDR 250, and an E-SMLC. There is an N3 interface between the RAN 170 and the core network 190. An LCS client 270 is able to communicate at least with the GMLC 260 and the UDM/UDR 250.

Having thus introduced suitable but non-limiting technical contexts for the practice of the exemplary embodiments, the exemplary embodiments will now be described with greater specificity.

The examples herein relate to apparatuses and methods for positioning wireless communication devices in cellular networks, such as cellular network 100. 3GPP TS 38.305 (see, e.g., 3GPP TS 38.305 V17.3.0 (2022-12)) defines these as follows (between opening and closing quotation marks):

### “5.4.5 Positioning Reference Unit (PRU)

A Positioning Reference Unit (PRU) at a known location can perform positioning measurements (e.g., RSTD, RSRP, UE Rx-Tx Time Difference measurements, etc.) and report these measurements to a location server. In addition, the PRU can transmit SRS to enable TRPs to measure and report UL positioning measurements (e.g., RTOA, UL-AoA, gNB Rx-Tx Time Difference, etc.) from PRU at a known location. The PRU measurements can be compared by a location server with the measurements expected at the known PRU location to determine correction terms for other nearby target devices. The DL and/or UL location measurements for other target devices can then be corrected based on the previously determined correction terms.”

From a location server perspective, the PRU functionality may be implemented in a UE with known location.

The use of positioning reference units (PRUs) with known locations for positioning UEs is useful, as there has been observed improvements in using PRUs for enhancing performance in positioning UEs.

Notes associated with this are as follows.
a) The term “positioning reference unit (PRU)” is only used as a terminology in this discussion. PRU does not necessarily mean an introduction of a new network node (e.g., the functionality of the PRU may be implemented in a UE or a radio access network (RAN node).
b) The PRU includes positioning functionalities. The positioning functionalities may include, but are not limited to, the following:
1. Providing positioning measurements (e.g., RSTD, RSRP, Rx-Tx time differences);
2. Transmitting the uplink sounding reference signals (UL SRS) for positioning.
c) The PRU may be requested by the LMF to provide its own known location information (e.g., its coordinates) to the LMF. If the antenna orientation information of the PRU is known, the antenna orientation information of the PRU may also be requested by the LMF.

The following specific problems are identified, and are some or all of these may be addressed herein.
1) One problem is how LMF (and/or AMF) determines the most suitable PRU(s) for a specific location request that request the position of a target UE. This further requires the following consideration: From an LMF perspective, at the time of receiving location request, the location of the target UE is unknown.
2) Majority of PRU are expected to be static, however, future use cases and may need PRUs that are mobile (e.g., whose location may change (e.g., due to mobility)). In these use cases, it is unclear how a 5GC, e.g., LMF, AMF, other NFs of a 5GC, would know if the PRU is static or mobile?
3) It is an issue as to how a PRU is used (e.g., by the LMF) for location determination of a particular target UE, e.g., enhancements to existing location determination procedures.
4) One further problem is to which NF(s) may take the role of LCS client, e.g., to send a request to the PRU for positioning UEs. Furthermore, the trigger in this case is currently not known.

Currently, the overall procedure for using PRUs remains open.

To address these and other problems, examples below include one or more of the following:
1) An overall discovery procedure and specific enhancements to discovery procedure of PRU(s);
2) Enhancements to the registration procedures specific to PRU, also possibly considering cellular networks comprising static PRUs as well as mobile PRUs;
3) Improvements to UE location determination accuracy using PRU as part of location determination procedure; and/or
4) Enhancements to the GMLC function, and, e.g., LMF logic, in determining target UE location with more accuracy.

Two examples are mainly described. PRU registration and creation and/or updating of PRU information in the 5GC are described as a first example (see FIGS. 3, 3A, 3B, and 3C), and the second example involves the UE's accurate location determination using a PRU (see FIGS. 4, spread over FIGS. 4A and 4B, 5A, 5B, and 5C). In particular, FIGS. 3, 4A, and 4B show control plane signaling (e.g., messages) that are sent between various entities in the cellular network, and operations performed by various these various entities in the cellular network. Meanwhile, 3A, 3B, and 3C are flowcharts performed by certain of the entities in the cellular network and relate to the control plane signaling and operations shown in FIG. 3. Similarly, FIGS. 5A, 5B, and 5C are flowcharts performed by certain of the entities in the cellular network and relate to the control plane signaling and operations shown in FIG. 4.

The first example involves PRU registration and creation and/or updating of PRU information in the 5GC. FIG. 3 shows an example of a detailed procedure of PRU registration (e.g., a procedure for registering a PRU with an AMF of the cellular network), and creation and/or updating PRU information, including possibly deletion of PRU information, in a database, e.g., UDM/UDR or GMLC and/or in an NRF. Once the PRU information is stored in the database(s), the PRU information is then available to be retrieved by other NFs, e.g., AMF, LMF. Further details of FIG. 3 are described in FIGS. 3A, 3B, and 3C.

At 1: A registration procedure is performed which is similar to the registration procedure specified, e.g., in 3GPP TS 23.502, 4.2.2.2.2. The registration procedure of the present disclosure includes an additional step not included in the registration procedure described in TS 23.502, 4.2.2.2.2. The additional step involves the PRU 210 indicating, via an indication, if the PRU is a static PRU or a mobile PRU. The registration procedure involves the PRU 210, the RAN node 170, and the serving AMF 220.

At 2: The serving AMF 220 selects an appropriate LMF 230 for the PRU 210. In this case, the LMF-PRU 230-1 is selected by the serving AMF 220.

At 3: Since the PRU 210 indicated to the serving AMF 220 that it is a “PRU” (e.g., with an indication whether this PRU is a static or mobile PRU) during the registration procedure, to the serving AMF 220, a network induced location request (NI-LR) procedure as described in 3GPP TS 23.273, 6.10.1-1 is performed after the registration procedure is successfully completed (i.e., the PRU successfully registers with the AMF 220) to obtain location information for the PRU 210. The location information for the PRU 210 may include a location of the PRU 210 (referred to a PRU location herein). The NI-LR procedure can involve the PRU 210, RAN 170, AMF 220, and LMF-PRU 230-1.

At 4: The LMF-PRU 230-1 sends the PRU location and possibly computed correction information (e.g., the LMF-PRU 230-1 sends an actual PRU location of the PRU or sends an offset value for the PRU location of the PRU as described below) to the serving AMF 220. The LMF-PRU 230-1 may send the PRU location to the serving AMF 220 by including the PRU location in a message and sending the message to the serving AMF 220. The message may comprise a Nlmf_Location_DetermineLocation response. It is further noted that the Nlmf_Location_Determine response is typically part of NI-LR procedure, but was shown in FIG. 3 as being “outside” the NI-LR procedure only for clarity purposes.

At 5/6: The serving AMF 220 then sends, to the GLMC, a request to update the PRU information stored in the GLMC. The request comprises PRU information, including an identifier of the serving AMF (“AMF ID”), an identifier of the selected LMF (“LMF ID”) or a URI for the selected LMF, an indication whether the PRU is a mobile PRU or a static PRU, PRU position information (such as actual PRU location and/or offset value), and the request is sent to either the GMLC 260 or to the UDM/UDR 250. As is known, the GMLC 260 is a network element (such as being a network function 199) that includes the functionality required to support location-based services. The unified data management (UDM) manages user data of users of the cellular network in a single, centralized network element, and this example has the UDM paired with the user data repository (UDR) (e.g., co-located in the centralized network element), which stores the user data of users of the cellular network. In this example, the serving AMF 220 (at 5) sends the PRU information to the GMLC 260. At 5a, the GMLC 260 maintains the PRU information. At 6, the AMF 220 provides (e.g., sends) the PRU information to the UDM/UDR 250, which at 6a stores the PRU information.

The illustrated repository 280 includes a database 281, comprising the PRU information (shown a PRU info in FIG. 3). The repository 280 could be UDM/UDR 250, GMLC 260, or the like, whichever has (or possibly has access to) the database 281.

FIG. 3A is a flowchart of a method performed by a PRU (e.g., PRU 210) shown in FIG. 3. In block 301, the PRU 210 performs a registration procedure to register the PRU with a cellular network (e.g., the serving AMF 220 of the cellular network), which causes the rest of a PRU registration (e.g., and an update) procedure and in particular an NI-LR procedure described above to be performed. In block 303, one option for block 301 is to indicate, as part of the registration procedure performed by the PRU. For example, during the registration procedure performed by the PRU 210, the PRU 210 sends, to the serving AMF 220, a registration request to register the PRU with the cellular network. The registration request may include an indication that the PRU 210 is a static PRU or an indication that the PRU 210 is a mobile PRU. In block 304, the PRU 210 participates in an NI-LR procedure to locate the PRU (e.g., to obtain the PRU location of the PRU 210) and associates the PRU 210 with the serving AMF 220 and LMF (referred to as the LMF-PRU for the LMF's association with the PRU).

Turning to FIG. 3B, this is a flowchart of a method performed by an AMF (e.g., the serving AMF 220) shown in FIG. 3. In block 305, in response to receipt of a registration request, sent by the PRU (e.g., PRU 210), to register the PRU with AMF, the AMF registers the PRU and sends a response to the registration request to the PRU which indicates acceptance of registration of the PRU. The request to register the PRU may include an indication whether the PRU is a static PRU or a mobile PRU. In block 310, the AMF 220 selects an LMF 230-1 for the registered PRU based on one or more criteria. These criteria can include one or more of the following: a serving area of an LMF 230, for example, if this LMF 230 serves a subset (i.e., less than all) of an area served by this AMF 220; or the AMF's internal implementation logic; and the like.

In block 315, the AMF 220 obtains the PRU location (e.g., a location of the PRU), in response to successful registration of the PRU using the NI-LR procedure described above, which associates an LMF with this PRU and AMF. It is noted that this block corresponds to 3 and 4 of FIG. 3. Itis further noted that 3 and 4 are not mandatory. For example, a PRU 210 may already have provided its location and the AMF 220 simply (after successful registration and the AMF 220 stores the PRU location in a repository (e.g., repository 280).

In block 320, the AMF 220 updates the PRU position information stored in the repository (e.g., repository 280). It is noted that information for/associated with position of a PRU is generally referred to as “PRU position information” hereinafter. Examples of block 320 are illustrated by blocks 325-345. Block 325 indicates that an update of PRU position information could be an initial update of the PRU position information or a subsequent update of the PRU position information. Block 330 corresponds to the initial update of the PRU position information, where if this is the initial update of the PRU position information, PRU position information comprises a PRU location. For a subsequent update of the PRU position information, block 335 is used, PRU position information is used. The PRU position information for subsequent updates could include the actual PRU location of the PRU and/or an offset value. The offset value for the PRU location of the PRU is a difference between a previously obtained PRU location or an initial PRU location (which stored in and retrieved from the repository) and a current PRU location as obtained as part of the update, e.g., blocks 315 and 320.

In block 340, other PRU information included in the PRU information (referred to as corresponding PRU information) may be included (e.g., as an initial update) or updated (e.g., as a subsequent update) in the repository, e.g., one or more of the following: AMF ID; LMF ID or LMF URI; indication of whether PRU is a mobile PRU or static PRU may be updated in the repository. The LMF ID or LMF URI may be used to identify the LMF serving the PRU. The LMF URI is a Uniform Resource Indicator, which is a unique sequence of characters that identifies a logical or physical resource used by web technologies. That is, both the LMF ID and LMF URI uniquely identify the particular LMF serving the PRU (the LMF-PRU 230-1 in this example). Block 345 indicates that the repository could be any of GMLC, UDM, UDR, NRF, or other network element that has a database 281 storing PRU information. It is noted that information for/associated with a PRU is generally referred to as “PRU information” hereinafter.

Referring to FIG. 3C, a flowchart is shown of a method performed by a repository in FIG. 3. The repository 280 in block 321 receives, from the AMF, PRU information including PRU position information and corresponding PRU information and stores the PRU information. The corresponding information (see block 341) includes one or more of the following: AMF ID, LMF ID or LMF URI; indication that the PRU is a mobile PRU or a static PRU. Block 326 indicates an update of PRU position information could be received where the update of the PRU position information could be an initial update of the position information or a subsequent update of the PRU position information. If the update of the PRU position information is an initial update of the PRU position information, the PRU position information is used in block 331 for an update and corresponding storage. If the update is a subsequent update of PRU position information, the update of the PRU position information may comprise an actual PRU location or an offset value that is used for the update and corresponding storage. As previously described, this offset value for the PRU location of the PRU is a difference between a previous PRU location or an initial PRU location (which is stored in and retrieved from the repository) and a current PRU location as obtained as part of the update.

A second example embodiment involves the accurate determination of a location a UE using PRU. FIG. 4, split over FIGS. 4A and 4B, shows an example of procedure of accurate determination of a location of a UE (e.g., a target UE's location) using a PRU. An LCS client may require a highly accurate location of a UE (e.g., a target UE). This embodiment assumes the PRU 210 is already registered to a cellular network, e.g., as shown in the FIG. 3 described previously.

At 1: The LCS client 270 requests a location of a target UE (e.g., a target UE's location). The request for the location of a target UE may be a high accuracy positioning request (e.g., the LCS Service Request shown in FIG. 4A). The LCS Service Request may include a target UE and also a QoS parameter for the LCS Service Request.

At 2: The GMLC 260 requests and receives the UE privacy settings for the target UE from the UDM/UDR 250 and confirms that the target UE is allowed to be located (e.g., the GMLC 260 is allowed to obtain the target UE's location). The GMLC 260 request the UE privacy settings for the target UE from the UDM/UDR 250 by sending a Nudm_SDM/UECM_get request that includes the target UE. The GMLC 260 receives, from the UDM/UDR 250, a response to the Nudm_SDM/UECM_get request that includes the UE privacy settings for the target UE.

At 3-5: The messaging is routed to the LMF-Target UE 230-2 through the serving AMF 220 of the target UE. As indicated in FIG. 4A, the GMLC 260 may send (step 3) a message (e.g., Namf_Location_ProvidePositioningInfo message) that includes an identifier of the target UE. The AMF 220 performs an LMF selection (for the target UE) in step 4 to selected a LMF for the target UE (e.g., selects LMF-Target UE 230-2). The AMF 220 in step 5 sends a message to the LMF-Target UE 230-2 that includes the target UE's ID and an identifier of a cell (e.g., cell ID in FIG. 4A) of a cell serving of the target UE. The message sent by the AMF 220 to the LMF-Target UE 230-2 may be the Namf_Location_DetermineLocation message shown in FIG. 4A). The cell ID and target UE ID included in Namf_Location_DetermineLocation message and are parameters of the signaling.

At 6: The LMF-Target UE 230-2 determines to use PRU 210 for obtaining the target UE's position or location, e.g., by applying any corrected position information derived earlier from the PRU position information (FIG. 3) or as determined in steps 9-11. This decision as to whether to use a PRU could be based on the QoS included in the LCS service request and/or positioning method to be used for calculating a location or position of the target UE, or the like.

It is noted that both the terms ‘position” and “location”, e.g., of UEs or PRUs, are used herein. This is common practice in this technology area. As used herein, however, the terms “position” and “location” are considered to be the same, even if referred to separately (e.g., “position or location”), and define one or more values that indicate where the device (UE or PRU) is in with (e.g., a coverage area of) the cellular network.

At 7: After the decision to use the correction factor is taken, the correct PRU 210 has to be selected for the target UE 110. To select the correct PRU for the target UE 110, the LMF-Target UE 230-2 first queries (step 7a) the GMLC 260 or UDM/UDR 250 to retrieve PRU information for the one or more PRUs. That is, the GMLC 260 or UDM/UDR 250 sends (e.g., via a reply) the PRU information for one or more PRUs to the LMF-Target UE 230-2. The LMF-Target UE 230-2 may therefore receive PRU information from multiple PRUs. The PRU information could include a tuple (e.g., with PRU ID of the PRU, AMF ID of AMF serving the PRU, cell ID of a cell serving the PRU, an LMF ID or LMF URI of a LMF serving the PRU, a geo-location of the PRU, and the like). Based on this, the LMF-Target UE 230-2 may perform filtering (step 7a) of this PRU information, e.g., by applying one or more filter criteria to select a most suitable PRU 210 that could be used for this target UE 110. Filter criteria may include one or more of the following: cell ID of the cell serving the target UE, the AMF ID of the serving AMF of the PRU, the LMF ID or LMF URI of the LMF serving the PRU, and the like. The PRU that is selected is the one that meets the filter criteria.

At 8: A positioning procedure to obtain a location information comprising for the target UE 110 is performed.

At 9: This step may be optional. This corresponds to the positioning procedure for the selected PRU, and may happen simultaneously with 8. This step is, however, triggered by the LMF responsible for the target UE (LMF-Target UE 230-2 in this example). The LMF in this case provides a callback URI together with PRU ID of the selected PRU to the AMF, via a LCS Service request.

It should be noted that this step (9) may also be a periodic step, e.g., to keep the PRU information for PRUs in the GMLC or UMD/UDR up to date and thus is triggered by LMF responsible for the PRU and/or the AMF (e.g., the LMF serving the PRU and/or serving the AMF).

It should also be noted that the AMF 220 here is the one to which this particular PRU 210 is currently registered, and thus this AMF 220 may be different than the AMF 220 to which LMF-Target UE 230-2 sends LCS Service request in step 8.

As one additional note, the LMF-Target UE 230-2 serving the target UE 110 may skip this step i.e., not initiate the determination of the PRU position and correction factor, e.g., in case the PRU information retrieved from GMLC or UDM/UDR is (indicated to be) up to date. In case of a static PRU, there is a smaller chance of a change to the PRU position and correction factor as compared to a mobile PRU, however, for both a static as well as a mobile PRU, the correction factor may change due to changes in the radio conditions.

At 10: The AMF 220 sends a location determination request to the LMF responsible for the PRU 210. The location determination request may be a Nlmf_Location_DetermineLocation request that includes a PRU ID of the PRU the LMF is responsible for (e.g., LMF-Target UE 230-2).

At 11: A PRU position procedure is performed, e.g., using the PRU 210 identified by PRU ID, to obtain PRU position information for the PRU identified by the PRU ID.

At 12: The LMF for the PRU 210 (e.g., LMF-PRU 230-1) provides PRU position information in a response to the location determination request sent by the AMF 220 in step 10, and also provides a corresponding PRU ID. It is noted that 11 and 12 may also be considered to be part of the PRU positioning procedure in step 11.

At 13: The AMF 220 updates the PRU information (info), stored in the GMLC 260 and/or UDM/UDR 250. For example, the PRU position information received from the LMF-230-1 in step 12 may include an actual PRU location for the PRU or offset value for the PRU location of the PRU). The AMF 220 may update the PRU information stored in the GMLC 260 by sending, to the GMLC 260, a message or signaling that includes the update to the PRU position information. It is noted that a similar a message or signaling may be sent by the AMF 220 to the UDM/UDR 250 in step 13a to update the PRU information stored in the UDM/UDR 250. This message or signaling is illustrated via a dashed line, indicating this is optional and includes the updated PRU position information.

At 14: The database in the repository, e.g., GMLC 260 and/or UDM/UDR 250 is updated with this update to the PRU information.

At 15: The GMLC 260 and/or UDM/UDR 250, if the PRU information is updated, notifies to the subscribed NFs, e.g., LMF-Target UE 230-2. The GMLC 260 and/or UDM/UDR 250 notifies the subscribed NFs by sending an event notify message that includes the updated PRU information, including the updated PRU position information.

At 16: This step is optional, as indicated by the dashed line. In response to step 9, the AMF 220 may directly provide to the LMF-Target UE 230-2, the PRU position information, e.g., location and correction factor as received in 12.

At 17: The LMF-Target UE 230-2 considers the PRU position information (such as the actual PRU location of the PRU or offset value for the PRU location of the PRU or possibly both) in determining the target UE location or position. That is, the LMF-Target UE 230-2 calculates or computes the target UE's location or position in step 17a, and the LMF-Target UE 230-2 can consider the PRU offset value when determining the target UE location or position.

At 18-19: The LMF-Target UE 230-2 provides (at 18) the target UE's location or position to the AMF 220. For example, the LMF-Target UE 230-2 provides the target UE's location or position in a response to the location determination request sent at 10, The response may be a Nlmf_Location_DetermineLocation response. At 19, the LMF-Target UE 230-2 provides the target UE's location or position to the GMLC 260, which then provides the target UE's location or position to the LCS client 270. The LMF-Target UE 230-2 may provide the target UE's location or position to the GMLC 260 by sending, to the GMLC 260 a response to the request sent at 3 (e.g., the Nlmf_Location_ProvidePositioningInfo request sent at 3). The response may be the Nlmf_Location_ProvidePositioningInfo response that includes the target UE's location or position. The GMLC 260 may provide the target UE's location or position to the LCS client 270 by sending a response to the LCR Service request sent at 1 (e.g., a response to the LCS service request sent at 1).

It should be noted that the proposed enhancement can be applied to both the MOLR and NILR procedures as well.

Referring now to FIG. 5A, a flowchart is illustrated of a method performed by a repository 280 in FIG. 4. In block 505, the repository 280 receives from LCS client a request for location of a target UE, which triggers a procedure for determination of an accurate location of the target UE. The repository 280 in block 510 determines which AMF is serving (i.e., associated with or responsible for) the target UE. The repository 280 in FIG. 4 may be the GMLC 260 or the UDM/UDR 250 shown in FIG. 4 for example. For ease of reference, the example of FIG. 5A considers both the UDM/UDR 250 and GMLC 260 as being the repository 280, although it is possible that only one of these functions would have a database 281 that stores PRU information for PRUs. The repository determines a suitable AMF serving (i.e., associated with or responsible for) the target UE and thus sends in step 3 of FIG. 4 a message to that AMF 220. In one example, an Nudm_SRM/UECM_get message that includes an identifier of the target UE is sent from the GMLC 260 to the UDM/UDR 250 to determine a suitable AMF that is serving (e.g., associated with or responsible for) the target UE, see FIG. 4, though this is but one example, to determine the AMF 220. A response to the Nudm_SRM/UECM_get message includes an identifier (e.g., AMF ID) of the suitable AMF.

In block 520, the repository 280 requests the determined AMF 220 provide position information for the target UE. The position information for the target UE may comprise a position or location of the target UE. For PRUs that are not serving (i.e., not associated with) the target UE, the LMF may decide, however, to use a specific PRU (referred to as a suitable PRU in FIG. 4) in order to obtain position information for the target UE that is used, along with position of the UE, for determining a more accurate position or location of the target UE (i.e., a resultant position or location of the target UE that is more accurate than only using the position or location of the target UE received from the target UE). That is, the PRU helps in determining more accurate position or location of the target UE, as compared to using only position information of the UE. Consequently, in block 565, the repository 280 receives a query (or queries), from the LMF serving (i.e., associated with or responsible for) the target UE, requesting PRU information for PRU(s) serving (e.g., associated with or responsible for) the target UE. The repository 280 stores PRU information for the PRUs serving (i.e., associated with or responsible for) the target UE. The PRU information for individual PRUs serving the target UE comprises one or more of the following: AMF ID of the AMF serving the target UE (generally referred to herein as the serving AMF), LMF ID or LMF URI of the LMF serving the target UE (generally referred to herein as the serving LMF), indication that the PRU is a mobile PRU or a static PRU; and/or PRU position information. Individual queries might include a set of input parameters comprising an identifier of serving area (or an identifier of a Tracking Area (e.g., a Track Area Identifier (ID)), LMF ID or LMF URI of a serving LMF, and/or AMF ID of a serving AMF. In block 569, the repository 280 responds, to LMF, with PRU information for PRU(s) serving (i.e., associated with or responsible for) the target UE that match of at least one of a set of provided input parameters. As one example, the PRU position information of a PRU (e.g., the actual (i.e., current) PRU location of the PRU and/or offset value for the PRU location of the PRU) is sent from the repository 280 to the LMF-Target UE 230-2, for individual ones of any PRUs that meet the matched version of at least one of a set of provided input parameters. The corresponding PRU ID(s) of the PRUs(s) may also be sent. The response could include a list of PRU IDs of multiple PRUs for instance, if there are multiple PRUs.

Blocks 570-585 correspond to a PRU location update procedure 590, e.g., as also shown via 13-15 in FIG. 4. In block 570, the repository 280 receives, from the AMF 220, updated PRU information of a PRU associated with the target UE 110. Block 575 indicates the updated PRU information may include an offset value for the PRU location of the PRU (or offset information indicative of an offset value) (i.e., a difference with respect to the PRU's previous PRU location of the PRU) or the current actual PRU location of the PRU, e.g., a newly determined PRU location (e.g., PRU may have moved to new location or position if the PRU is a mobile PRU or even if the PRU is a static PRU due to interference and the like, which results in a change in location or position of the PRU). That is, for a static PRU, there is the possibility that the earlier determined location or position of the PRU was less accurate due to radio signal interference, environment, and the like, and updating to a current location or position of the PRU would result in a change in a measurement used to determine the location or position of the PRU. In block 580, the repository 280 updates PRU position information for the PRU using the actual PRU location of the PRU or offset value for the PRU location of the PRU. In block 585, the repository 280 notifies the LMF with the updated PRU position information.

Turning to FIG. 5B, a flowchart is illustrated of a method performed by an AMF (e.g., AMF 220 in FIG. 4). In block 521, the AMF receives, from a repository, a request for the AMF to provide position information of the target UE. In block 523, the AMF selects an LMF to use for target UE. As previously described, this selection could use several criteria: e.g., serving area of the LMF (for example, if the LMF serves subset of area served by the AMF) or AMF's internal implementation logic, and the like. In block 525, the AMF sends a location request, including an identifier of the target UE (e.g., target UE ID) and an identifier of a cell (e.g., a cell ID) (which is known by the AMF), for a cell serving the target UE to the LMF. It is noted that LMFs for the PRU and target UE might be the same LMF, although in FIG. 4, these are different LMFs.

In block 528, the AMF performs a procedure to determine a position or location of the target UE, e.g., using target UE 110, PRU 210, RAN 170, LMF-PRU 230-1 and LMF-target UE 230-2. The AMF, in block 530, receives a request for a position or location of the target UE from the LMF-target UE 230-2. The request received by the AMF includes an identifier of a PRU (e.g., PRU ID of a PRU) and callback URI, where the callback URI links the request to the target UE, and is used by the AMF to identify that this request relates to the request in step 5 of FIG. 4. In block 532, the AMF sends location information for the target UE 110 (e.g., the position or location of the target UE) to the LMF-PRU 230-1, including PRU ID of the PRU 210. The AMF, in block 534, participates in a process to determine a current PRU position information for the PRU (e.g., a current PRU location of the PRU). The AMF 220 receives a response from the LMF-PRU 230-1, with the corresponding PRU ID of the PRU. See block 536.

In block 538, the AMF performs a process to update PRU position information stored in the repository 280. As previously described, this process may be performed for both cases of a static PRU or a mobile PRU. The AMF performs the process only to update the actual (e.g., current) PRU location of the PRU and/or the offset value of the PRU location of the PRU (although the process may also update other PRU information such as the AMF ID and LMF ID, if changed), see block 540. In the repository 280, however, based on the initial PRU information due to the registration procedure in FIG. 3 (see PRU registration in 1) may include the following: AMF ID of the AMF serving the PRU, LMF ID or LMF URI of the LMF serving the PRU, an indication of that the PRU is a mobile PRU of a static PRU, and/or PRU position information. The indication that the PRU is a mobile PRU or a static PRU may be information stored a single time, e.g., already stored due to the PRU registration procedure of FIG. 3.

In block 545, the AMF sends, to the LMF-target UE 230-2, a response to the location request that includes the PRU information. The response may include the PRU ID of the PRU 210 and the callback URI. In block 550, the AMF 220 receives, from LMF-Target UE 230-2, location information for the target UE 110. The location or position for the target UE 110 is determined by the LMF-Target UE 230-2 based on both the target UE location information received from the target UE and PRU position information received from the PRU. In block 553, the AMF sends location or position for the target UE 110 to the repository 280 (e.g., GMLC 260 in FIG. 4) for forwarding to the LCS client 270.

Referring to FIG. 5C, a flowchart is shown of a method performed by an LMF serving (i.e., associated with or responsible for) a target UE (shown as LMF-Target UE 230-2 in FIG. 4). In block 555, the LMF serving the target UE (e.g., the LMF-Target UE 230-2) receives, from the AMF, a location request for a location of the target UE. The request includes an identifier of the target UE (e.g., target UE ID) and an identifier of a cell (e.g., cell ID), for a cell serving the target UE. The LMF serving the target UE (e.g., the LMF-Target UE 230-2) determines (block 557) to use a PRU based on an indication that an accurate location of the target UE is to be determined included in the location request. The indication included in the location request may be a QoS requirement for the location of the target UE and/or positioning method). In other words, as explained previously, an accurate location of the UE could be used when the QoS requirement is above some threshold QoS requirement, such that having a more accurate position of the UE could help in providing better QoS. Similarly, a positioning method that is indicated could be one that requires a higher accuracy relative to another positioning method that is indicated. It is further noted that “accurate location” in block 557 and similar uses is a relative term and means that the combination of PRU position and UE position should yield a position of the UE that is more accurate than only using the position of the UE.

In block 558, the LMF serving the target UE queries the repository 280 for PRU position information of PRUs near the target UE. The individual queries might include a set of input parameters comprising an indication of a serving area (or an identifier of tracking area), a LMF ID or LMF-URI of the serving LMF, and/or the AMF ID of the serving AMF.

The LMF, in block 559, selects a suitable PRU for the target UE by examining PRU position information, e.g., the PRU which indicates a tracking area identifier of a tracking area that includes a cell ID (e.g., as received in step 5 of FIG. 4) or the one served by the same AMF (to which this LMF is also serving the target UE for this location service request). The selection of a suitable PRU in block 559 may be mainly based on cell ID, as target UE is likely located in this cell ID and PRU to be selected in this area. The responses to the queries in block 558 may be filtered (block 560), during the selection of block 559, by the LMF, using e.g.: an AMF ID of the serving AMF; a cell ID of the serving cell; and/or a LMF ID or LMF URI of the serving LMF. In block 561, the LMF participates in a procedure to determine location information of the target UE.

The LMF, in block 563, sends a location service request to the AMF with PRU ID and callback URI (latter used by AMF to identify that this request relates to the request in step 5 of FIG. 4). In block 564, the LMF receives updated PRU position information, if any, from the repository 280, and the LMF receives (block 566) a response from the AMF 220 with PRU position information (e.g., actual PRU location of the PRU or offset value of the PRU location of the PRU). As described previously, this could be performed by a message of Namf_Location_Provide PositioningInfo Response and may be optional. For instance, if the LMF receives updated PRU information from the repository in block 564, then PRU information also received from the AMF 220 in block 566 could be redundant.

In block 567, the LMF calculates or computes a location or position of the target UE considering PRU position information and the location information of the target UE (determined in block 561). In block 568, the LMF (e.g., LMF-Target UE 230-2) sends the location information of the target UE to the AMF 220. The location information comprises the location or the position of the target UE.

Without in any way limiting the scope, interpretation, or application of the claims appearing below, a technical effect and/or advantage of one or more of the example embodiments disclosed herein is that the examples build on top of existing functionality-hence, it may be evolutionary in nature and easy to implement for product teams. Another technical effect and/or advantage of one or more of the example embodiments disclosed herein is the examples are generic and can apply to all scenarios-same LMF for PRU and target UE or otherwise.

The following are additional examples.

Example 1. A method, comprising: requesting, by a positioning reference unit within a cellular network, registration of the positioning reference unit with the cellular network; and participate, by the positioning reference unit with one or more network elements in the cellular network, in a procedure to locate the positioning reference unit within the cellular network and to associate this positioning reference unit as a positioning reference unit with at least one network element in the cellular network.

Example 2. The method according to example 1, wherein requesting registration of the positioning reference unit comprises sending, to the cellular network, a registration request to register the positioning reference unit, the registration request comprising an indication that the positioning reference unit is a static positioning reference unit or a mobile positioning reference unit.

Example 3. The method according to any one of examples 1 or 2, further comprising participating, by the positioning reference unit, in a procedure to determine position of a target user equipment in the cellular network.

Example 4. The method according to any one of examples 1 to 3, further comprising participating, by the positioning reference unit with one or more network elements in the cellular network, in a second procedure to locate the positioning reference unit within the cellular network.

Example 5. The method according to any one of examples 1 to 4, further comprising receiving a response to association of this positioning reference unit as a positioning reference unit, the response comprising an indication of acceptance of registration of the positioning reference unit.

Example 6. The method according to any one of examples 1 to 5, wherein the one or more network elements comprise an access and mobility management function or a location management function of the cellular network, and the positioning reference unit comprises a user equipment in the cellular network.

Example 7. A method, comprising: at a first network element in a cellular network, obtaining information for a positioning reference unit in the cellular network; and providing, by the first network element to a repository, at least the information for the positioning reference unit, for storage by the repository for use in positioning a user equipment in the cellular network.

Example 8. The method according to example 7, wherein the information for the positioning reference unit comprises one or more of the following: an identifier of the first network element; an identifier of a location management function; a uniform resource identifier indicative of the location management function; an indication of whether a positioning reference unit corresponding to the information for the positioning reference unit is a mobile positioning reference unit or a static positioning reference unit; or position information corresponding to a position of the positioning reference unit in the cellular network.

Example 9. The method according to example 8, wherein the position information comprises one or more of an actual location of the positioning reference unit or an offset value for a location of the position reference unit.

Example 10. The method according to any one of examples 7 to 9, wherein the repository comprises one of a unified data management element, unified data repository element, gateway mobile location center element or network repository function.

Example 11. A method, comprising: receiving, by a repository for a cellular network, information for a positioning reference unit describing at least a position of the positioning reference unit in the cellular network; storing by the repository the information for the positioning reference unit; and in response to a request by a requesting network element for positioning information of the positioning reference unit, sending, by the repository, at least part of the information for the positioning reference unit to the requesting network element.

Example 12. The method according to example 11, further comprising: receiving, by the repository from a location services client, a service request for a location of a target user equipment; determining, by the repository, a network element implementing an access and mobility management function in the cellular network that is associated with the target user equipment; and requesting, by the repository, the determined network element implementing the access and mobility management function provide positioning information of the target user equipment.

Example 13. The method according to example 12, further comprising: receiving, by the repository and in response to the requesting that the determined network element provides location information for the target user equipment, one or more queries from a network element implementing a location management function requesting information about which positioning reference units are associated with a target user equipment, each respective query of the one or more queries comprising one or more input parameters; and responding, by the repository to the network element implementing the location management function, with information for a positioning reference unit for one or more positioning reference units whose information for the positioning reference unit matches at least one of the one or more input parameters.

Example 14. The method according to example 13, wherein the one or more input parameters comprise one or more of the following: indication of a serving area of the positioning reference unit; indication of a tracking area of a corresponding positioning reference unit, an identifier of a location management function that serves the target user equipment; or an identifier of an access and mobility management function that serves the target user equipment.

Example 15. The method according to any one of examples 13 or 14, wherein the information for the positioning reference unit associated with the one or more positioning reference units comprises, for individual positioning reference units, an identifier of the individual positioning reference unit and one or both of an actual location of the individual positioning reference unit in the cellular network or an offset value for the location of the individual positioning reference unit in the cellular network.

Example 16. A method, comprising: receiving, at a first network element in a cellular network, a request for positioning of a target user equipment from a repository in the cellular network; selecting a second network element in the cellular network that serves the target user equipment; sending, from the first network element to the second network element, a location request for a location of the target user equipment; receiving, by the first network element from the second network element, a response to the location request comprising an identifier of a positioning reference unit associated with the target user equipment and to be used for determining a position of the target user equipment; determining, by the first network element, position information of the positioning reference unit; and updating, by the first network element, the repository with the position information of the positioning reference unit serving the target user equipment, the position information corresponding to the positioning reference unit to be used for the positioning of the target user equipment.

Example 17. The method according to example 16, further comprising sending a request for a location determination from the first network element to a third network element that corresponds to the positioning reference unit, and receiving a response, by the first network element from the third network element, of the location determination of the positioning reference unit from the third network element.

Example 18. The method according to example 16 or 17, further comprising: receiving, by the first network element, indication of the positioning of the target user equipment, the positioning based on both position of the target user equipment and position of the positioning reference unit; and sending, by the first network element to the repository, the indication of the positioning of the target user equipment.

Example 19. The method according to any one of examples 16 to 18, wherein: the first network element implements an access and mobility management function in the cellular network; and the second network element implements a location management function in the cellular network.

Example 20. A method, comprising: receiving, at a network element implementing a location management function in a cellular network and from a first network element, a request for positioning of a target user equipment; selecting a positioning reference unit serving the target user equipment, wherein the positioning reference unit is able to provide positioning information associated with itself to the cellular network; receiving, by the network element, a first location of the target user equipment; determining, by the network element, a final location of the target user equipment considering position information of the positioning reference unit and the first location of the target user equipment; and providing by the network element the final location of the target user equipment to the first network element.

Example 21. The method according to example 20, wherein the network element determines to perform at least the selecting the positioning reference unit based on one or both of a requirement for quality of service for the positioning of the target user equipment or a positioning method to be used for calculating position of the target user equipment.

Example 22. The method according to any one of examples 20 or 21, wherein the network element selects the positioning reference unit at least by: querying a repository for suitable positioning reference units that could have positioning information corresponding to the target user equipment, and receiving a reply comprising one or more entries, individual entries corresponding to one of multiple possible positioning reference units; and filtering the entries by one or more criteria to determine a positioning reference unit that meets the one or more criteria and that is the selected positioning reference unit that serves the target user equipment.

Example 23. The method according to example 22, wherein the one or more criteria comprise one or more of the following: an identifier of a positioning reference unit; an identifier of a network element that implements an access and mobility management function and that serves the target user equipment; an identifier of a serving cell, an identifier of a location management function; or a geo-location of the positioning reference unit.

Example 24. The method according to any one of examples 20 to 23, further comprising sending by the network element a request to the first network element, the request comprising an identifier of the positioning reference unit and a uniform resource identifier of the network element.

Example 25. The method according to any one of examples 20 to 24, wherein: the method further comprises, prior to the determining the final location, receiving, by the network element from another network element, updated position information for the positioning reference unit; and the determining comprises determining the final location of the target user equipment based on the updated position information for the positioning reference unit.

Example 26. An apparatus, comprising: one or more processors; and one or more memories storing instructions that, when executed by the one or more processors, cause the apparatus at least to perform: requesting, by a positioning reference unit within a cellular network, registration of the positioning reference unit with the cellular network; and participate, by the positioning reference unit with one or more network elements in the cellular network, in a procedure to locate the positioning reference unit within the cellular network and to associate this positioning reference unit as a positioning reference unit with at least one network element in the cellular network.

Example 27. The apparatus according to example 26, wherein requesting registration of the positioning reference unit comprises sending, to the cellular network, a registration request to register the positioning reference unit, the registration request comprising an indication that the positioning reference unit is a static positioning reference unit or a mobile positioning reference unit.

Example 28. The apparatus according to any one of examples 26 or 27, wherein the one or more memories further store instructions that, when executed by the one or more processors, cause the apparatus at least to perform: participating, by the positioning reference unit, in a procedure to determine position of a target user equipment in the cellular network.

Example 29. The apparatus according to any one of examples 26 to 28, wherein the one or more memories further store instructions that, when executed by the one or more processors, cause the apparatus at least to perform: participating, by the positioning reference unit with one or more network elements in the cellular network, in a second procedure to locate the positioning reference unit within the cellular network.

Example 30. The apparatus according to any one of examples 26 to 29, wherein the one or more memories further store instructions that, when executed by the one or more processors, cause the apparatus at least to perform: receiving a response to association of this positioning reference unit as a positioning reference unit, the response comprising an indication of acceptance of registration of the positioning reference unit.

Example 31. The apparatus according to any one of examples 26 to 30, wherein the one or more network elements comprise an access and mobility management function or a location management function of the cellular network, and the positioning reference unit comprises a user equipment in the cellular network.

Example 32. An apparatus, comprising: one or more processors; and one or more memories storing instructions that, when executed by the one or more processors, cause the apparatus at least to perform: at a first network element in a cellular network, obtaining information for a positioning reference unit in the cellular network; and providing, by the first network element to a repository, at least the information for the positioning reference unit, for storage by the repository for use in positioning a user equipment in the cellular network.

Example 33. The apparatus according to example 32, wherein the information for the positioning reference unit comprises one or more of the following: an identifier of the first network element; an identifier of a location management function; a uniform resource identifier indicative of the location management function; an indication of whether a positioning reference unit corresponding to the information for the positioning reference unit is a mobile positioning reference unit or a static positioning reference unit; or position information corresponding to a position of the positioning reference unit in the cellular network.

Example 34. The apparatus according to example 33, wherein the position information comprises one or more of an actual location of the positioning reference unit or an offset value for a location of the position reference unit.

Example 35. The apparatus according to any one of examples 32 to 34, wherein the repository comprises one of a unified data management element, unified data repository element, gateway mobile location center element or network repository function.

Example 36. An apparatus, comprising: one or more processors; and one or more memories storing instructions that, when executed by the one or more processors, cause the apparatus at least to perform: receiving, by a repository for a cellular network, information for a positioning reference unit describing at least a position of the positioning reference unit in the cellular network; storing by the repository the information for the positioning reference unit; and in response to a request by a requesting network element for positioning information of the positioning reference unit, sending, by the repository, at least part of the information for the positioning reference unit to the requesting network element.

Example 37. The apparatus according to example 36, wherein the one or more memories further store instructions that, when executed by the one or more processors, cause the apparatus at least to perform: receiving, by the repository from a location services client, a service request for a location of a target user equipment; determining, by the repository, a network element implementing an access and mobility management function in the cellular network that is associated with the target user equipment; and requesting, by the repository, the determined network element implementing the access and mobility management function provide positioning information of the target user equipment.

Example 38. The apparatus according to example 37, wherein the one or more memories further store instructions that, when executed by the one or more processors, cause the apparatus at least to perform: receiving, by the repository and in response to the requesting that the determined network element provides location information for the target user equipment, one or more queries from a network element implementing a location management function requesting information about which positioning reference units are associated with a target user equipment, each respective query of the one or more queries comprising one or more input parameters; and responding, by the repository to the network element implementing the location management function, with information for a positioning reference unit for one or more positioning reference units whose information for the positioning reference unit matches at least one of the one or more input parameters.

Example 39. The apparatus according to example 38, wherein the one or more input parameters comprise one or more of the following: indication of a serving area of the positioning reference unit; indication of a tracking area of a corresponding positioning reference unit, an identifier of a location management function that serves the target user equipment; or an identifier of an access and mobility management function that serves the target user equipment.

Example 40. The apparatus according to any one of examples 38 or 39, wherein the information for the positioning reference unit associated with the one or more positioning reference units comprises, for individual positioning reference units, an identifier of the individual positioning reference unit and one or both of an actual location of the individual positioning reference unit in the cellular network or an offset value for the location of the individual positioning reference unit in the cellular network.

Example 41. An apparatus, comprising: one or more processors; and one or more memories storing instructions that, when executed by the one or more processors, cause the apparatus at least to perform: receiving, at a first network element in a cellular network, a request for positioning of a target user equipment from a repository in the cellular network; selecting a second network element in the cellular network that serves the target user equipment; sending, from the first network element to the second network element, a location request for a location of the target user equipment; receiving, by the first network element from the second network element, a response to the location request comprising an identifier of a positioning reference unit associated with the target user equipment and to be used for determining a position of the target user equipment; determining, by the first network element, position information of the positioning reference unit; and updating, by the first network element, the repository with the position information of the positioning reference unit serving the target user equipment, the position information corresponding to the positioning reference unit to be used for the positioning of the target user equipment.

Example 42. The apparatus according to example 41, wherein the one or more memories further store instructions that, when executed by the one or more processors, cause the apparatus at least to perform: sending a request for a location determination from the first network element to a third network element that corresponds to the positioning reference unit, and receiving a response, by the first network element from the third network element, of the location determination of the positioning reference unit from the third network element.

Example 43. The apparatus according to example 41 or 42, wherein the one or more memories further store instructions that, when executed by the one or more processors, cause the apparatus at least to perform: receiving, by the first network element, indication of the positioning of the target user equipment, the positioning based on both position of the target user equipment and position of the positioning reference unit; and sending, by the first network element to the repository, the indication of the positioning of the target user equipment.

Example 44. The apparatus according to any one of examples 41 to 43, wherein: the first network element implements an access and mobility management function in the cellular network; and the second network element implements a location management function in the cellular network.

Example 45. An apparatus, comprising: one or more processors; and one or more memories storing instructions that, when executed by the one or more processors, cause the apparatus at least to perform: receiving, at a network element implementing a location management function in a cellular network and from a first network element, a request for positioning of a target user equipment; selecting a positioning reference unit serving the target user equipment, wherein the positioning reference unit is able to provide positioning information associated with itself to the cellular network; receiving, by the network element, a first location of the target user equipment; determining, by the network element, a final location of the target user equipment considering position information of the positioning reference unit and the first location of the target user equipment; and providing by the network element the final location of the target user equipment to the first network element.

Example 46. The apparatus according to example 45, wherein the network element determines to perform at least the selecting the positioning reference unit based on one or both of a requirement for quality of service for the positioning of the target user equipment or a positioning apparatus to be used for calculating position of the target user equipment.

Example 47. The apparatus according to any one of examples 45 or 46, wherein the network element selects the positioning reference unit at least by: querying a repository for suitable positioning reference units that could have positioning information corresponding to the target user equipment, and receiving a reply comprising one or more entries, individual entries corresponding to one of multiple possible positioning reference units; and filtering the entries by one or more criteria to determine a positioning reference unit that meets the one or more criteria and that is the selected positioning reference unit that serves the target user equipment.

Example 48. The apparatus according to example 47, wherein the one or more criteria comprise one or more of the following: an identifier of a positioning reference unit; an identifier of a network element that implements an access and mobility management function and that serves the target user equipment; an identifier of a serving cell, an identifier of a location management function; or a geo-location of the positioning reference unit.

Example 49. The apparatus according to any one of examples 45 to 48, wherein the one or more memories further store instructions that, when executed by the one or more processors, cause the apparatus at least to perform: sending by the network element a request to the first network element, the request comprising an identifier of the positioning reference unit and a uniform resource identifier of the network element.

Example 50. The apparatus according to any one of examples 45 to 49, wherein: the apparatus further comprises, prior to the determining the final location, receiving, by the network element from another network element, updated position information for the positioning reference unit; and the determining comprises determining the final location of the target user equipment based on the updated position information for the positioning reference unit.

As used in this application, the term “circuitry” may refer to one or more or all of the following:
(a) hardware-only circuits (such as analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term means in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Embodiments B of the network functions described herein may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with examples of computers described and depicted, e.g., in FIG. 1. A computer-readable medium may comprise a computer-readable storage medium (e.g., memories 125 or other device) that may be any media or means that can contain, store, and/or transport the instructions for use by or in connection with an instruction execution system, apparatus, or device, such as a computer. A computer-readable storage medium does not comprise propagating signals, and therefore may be considered to be non-transitory. The term “non-transitory”, as used herein, is a limitation of the medium itself (i.e., tangible, not a signal) as opposed to a limitation on data storage persistency (e.g., RAM, random access memory, versus ROM, read-only memory).

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:
5G fifth generation
5GC fifth generation core
AMF access and mobility management function
AoA angle of arrival
API application programmer interface
DL downlink (from network to UE)
eNB (or eNodeB)
evolved Node B (e.g., an LTE base station)
evolved serving mobile location center
E-SMLC
HGMLC
Home GMLC
Gateway Mobile Location Center
GMLC
GPS global positioning system
gNB (or gNodeB) base station for 5G/NR
ID identification
I/F interface
info information
LCS LoCation Services
LDR Location Deferred Request
LMF Location Management Function
LPI LCS Privacy Indicator
LRF Location Retrieval Function
LTE long term evolution
MO-LR or MOLR Mobile Originated Location Request
MT-LR Mobile Terminated Location Request
MME mobility management entity
NF network function
ng or NG next generation
ng-eNB or NG-eNB next generation eNB
NI-LR or NILR Network Induced (or initiated) Location Request
NF network function
NR new radio
NRF Network Repository Function
N/W or NW network
PMD Pseudonym mediation device functionality
PRU Positioning Reference Unit
QOS quality of service
RAN radio access network
Rel release
RLC radio link control
RRH remote radio head
RRC radio resource control
RSTD reference signal time difference
RSRP Reference signal received power
RTOA relative time of arrival
RU radio unit
Rx receiver
SA2 SA Working Group 2, System Architecture and Services
SBA service-based architecture
SGW serving gateway
SMF session management function
SRS sounding reference signal
TRP transmission-reception point
Tx transmitter
UDM unified data management
UDR unified data repository
UE user equipment (e.g., a wireless, typically mobile device)
UI user interface
UL uplink (from UE to network)
UPF user plane function
URI Uniform Resource Identifier

What is claimed is:

1. An apparatus, comprising:
one or more processors; and
one or more memories storing instructions that, when executed by the one or more processors, cause the apparatus at least to perform:
requesting, by a positioning reference unit within a cellular network, registration of the positioning reference unit with the cellular network; and
participate, by the positioning reference unit with one or more network elements in the cellular network, in a procedure to locate the positioning reference unit within the cellular network and to associate this positioning reference unit as a positioning reference unit with at least one network element in the cellular network.

2. The apparatus according to claim 1, wherein requesting registration of the positioning reference unit comprises sending, to the cellular network, a registration request to register the positioning reference unit, the registration request comprising an indication that the positioning reference unit is a static positioning reference unit or a mobile positioning reference unit.

3. The apparatus according to claim 1, wherein the one or more memories further store instructions that, when executed by the one or more processors, cause the apparatus at least to perform: participating, by the positioning reference unit, in a procedure to determine position of a target user equipment in the cellular network.

4. The apparatus according to claim 1, wherein the one or more memories further store instructions that, when executed by the one or more processors, cause the apparatus at least to perform: participating, by the positioning reference unit with one or more network elements in the cellular network, in a second procedure to locate the positioning reference unit within the cellular network.

5. The apparatus according to claim 1, wherein the one or more memories further store instructions that, when executed by the one or more processors, cause the apparatus at least to perform: receiving a response to association of this positioning reference unit as a positioning reference unit, the response comprising an indication of acceptance of registration of the positioning reference unit.

6. The apparatus according to claim 1, wherein the one or more network elements comprise an access and mobility management function or a location management function of the cellular network, and the positioning reference unit comprises a user equipment in the cellular network.

7. An apparatus, comprising:
one or more processors; and
one or more memories storing instructions that, when executed by the one or more processors, cause the apparatus at least to perform:
receiving, by a repository for a cellular network, information for a positioning reference unit describing at least a position of the positioning reference unit in the cellular network;
storing by the repository the information for the positioning reference unit; and
in response to a request by a requesting network element for positioning information of the positioning reference unit, sending, by the repository, at least part of the information for the positioning reference unit to the requesting network element.

8. The apparatus according to claim 7, wherein the one or more memories further store instructions that, when executed by the one or more processors, cause the apparatus at least to perform:
receiving, by the repository from a location services client, a service request for a location of a target user equipment;
determining, by the repository, a network element implementing an access and mobility management function in the cellular network that is associated with the target user equipment; and
requesting, by the repository, the determined network element implementing the access and mobility management function provide positioning information of the target user equipment.

9. The apparatus according to claim 8, wherein the one or more memories further store instructions that, when executed by the one or more processors, cause the apparatus at least to perform:
receiving, by the repository and in response to the requesting that the determined network element provides location information for the target user equipment, one or more queries from a network element implementing a location management function requesting information about which positioning reference units are associated with a target user equipment, each respective query of the one or more queries comprising one or more input parameters; and
responding, by the repository to the network element implementing the location management function, with information for a positioning reference unit for one or more positioning reference units whose information for the positioning reference unit matches at least one of the one or more input parameters.

10. The apparatus according to claim 9, wherein the one or more input parameters comprise one or more of the following: indication of a serving area of the positioning reference unit; indication of a tracking area of a corresponding positioning reference unit, an identifier of a location management function that serves the target user equipment; or an identifier of an access and mobility management function that serves the target user equipment.

11. The apparatus according claim 9, wherein the information for the positioning reference unit associated with the one or more positioning reference units comprises, for individual positioning reference units, an identifier of the individual positioning reference unit and one or both of an actual location of the individual positioning reference unit in the cellular network or an offset value for the location of the individual positioning reference unit in the cellular network.

12. An apparatus, comprising:
one or more processors; and
one or more memories storing instructions that, when executed by the one or more processors, cause the apparatus at least to perform:
receiving, at a network element implementing a location management function in a cellular network and from a first network element, a request for positioning of a target user equipment;
selecting a positioning reference unit serving the target user equipment, wherein the positioning reference unit is able to provide positioning information associated with itself to the cellular network;
receiving, by the network element, a first location of the target user equipment;
determining, by the network element, a final location of the target user equipment considering position information of the positioning reference unit and the first location of the target user equipment; and
providing by the network element the final location of the target user equipment to the first network element.

13. The apparatus according to claim 12, wherein the network element determines to perform at least the selecting the positioning reference unit based on one or both of a requirement for quality of service for the positioning of the target user equipment or a positioning apparatus to be used for calculating position of the target user equipment.

14. The apparatus according to claim 12, wherein the network element selects the positioning reference unit at least by:
querying a repository for suitable positioning reference units that could have positioning information corresponding to the target user equipment, and receiving a reply comprising one or more entries, individual entries corresponding to one of multiple possible positioning reference units; and
filtering the entries by one or more criteria to determine a positioning reference unit that meets the one or more criteria and that is the selected positioning reference unit that serves the target user equipment.

15. The apparatus according to claim 14, wherein the one or more criteria comprise one or more of the following: an identifier of a positioning reference unit; an identifier of a network element that implements an access and mobility management function and that serves the target user equipment; an identifier of a serving cell, an identifier of a location management function; or a geo-location of the positioning reference unit.

16. The apparatus according to claim 12, wherein the one or more memories further store instructions that, when executed by the one or more processors, cause the apparatus at least to perform: sending by the network element a request to the first network element, the request comprising an identifier of the positioning reference unit and a uniform resource identifier of the network element.

17. The apparatus according to claim 12, wherein:
the apparatus further comprises, prior to the determining the final location, receiving, by the network element from another network element, updated position information for the positioning reference unit; and
the determining comprises determining the final location of the target user equipment based on the updated position information for the positioning reference unit.
